(19) United States
(12) Patent Application Publication
(10) Pub. No.: US 2008/0164199 A1
(43) Pub. Date: Jul. 10, 2008

(54) Device For Treating Aqueous Liquids

(75) Inventor: Paul Navaratna Seneviratne, Singapore (SG)

Correspondence Address: INTELLECTUAL PROPERTY / TECHNOLOGY LAW, PO BOX 14329, RESEARCH TRIANGLE PARK, NC, 27709, US

(73) Assignee: SIF TECHNOLOGIES PTE LTD, (SG)

(21) Appl. No.: 11/908,938

(22) PCT Filed: Mar. 17, 2005
(86) PCT No.: PCT/SG2005/000083

§ 371 Date: Sep. 17, 2007

(51) Int. Cl. C02F 1/00

(52) U.S. Cl. 210/252

(57) ABSTRACT

A device for treating aqueous liquids is disclosed comprising at least 2 treatment units connected in series, each treatment unit comprising a liquid inlet, a liquid outlet, a flow compartment fluidly connecting said liquid inlet to said liquid outlet, and cavitation inducing means for inducing cavitation in an aqueous liquid to be treated, said means comprising constriction means provided at the liquid inlet and/or the liquid outlet for increasing the velocity of the aqueous liquid, thereby reducing liquid pressure.

The invention relates to a device for treating aqueous liquids.

Methods and devices for treating aqueous liquids such as tap water, ground water, unprocessed precipitation and industrial water, as well as other consumable liquids with a view to improving its quality for consumption have been the subject of study for many years. For many years, physical processes such as distillation, filtration, adsorption and aeration have been employed to remove physical impurities, and chemical processes such as the use of additives like chlorine for as a sterilizing agent have been employed to condition the water and to destroy harmful micro-organisms in the water.

More recently, efforts have been directed at the study of the cluster structure of water and other aqueous liquids and the processes which are capable of altering the cluster structures of various types of molecules. Saykally and co-workers (N. Pugliano and R. J. Saykally, Science 1992, 257, 1937-1940; J D Cruzan et al., Science 1996, 271, 59-62; Liu et al., 1996, 271, 62-64; Liu et al., Science, 1996, 271, 929-933) have found that that water molecules in liquid state are capable of aggregating to form a myriad of cluster structures, including two-dimensional dimers, quasi-planar cyclic structures such as trimers, tetramers and pentamers. Computer simulations and thermodynamic models suggest that cyclic hexamers are also one of the prominent morphologies in water (Ralf Ludwig, Chem Phys Chem, 2000, 1, 53-56). It is postulated that as the size of the cluster increases, the ability of water to diffuse through biological material such as cell membranes decreases due to the affinitive forces present within each cluster that restricts the free movement of water molecules through membranes. As a result, when water having large cluster size (hereinafter known as “clustered water”) is consumed, the rate at which the water is absorbed is diminished.

One method which has been proposed for treating clustered water is the use of cavitation to breakdown the attractive forces between the water molecules, thereby rendering smaller the cluster size. Cavitation is a process commonly associated with the operation of water pumps. Classical cavitation is initiated when the absolute pressure of a moving liquid is reduced to about the vapor pressure of the liquid, resulting in the vaporization of the liquid. Vapor pockets (bubbles) are then formed in the liquid. The drop in the pressure of the liquid results from factors such as friction losses and also due to variations in velocity of the fluid inside the pump. As the rotating impeller vanes of the pump come into contact with the bubbles, the liquid is once again subjected to a higher pressure, and the pressure may once again exceed the vapor pressure and cause the bubbles to collapse/implode.

U.S. Pat. No. 6,521,248 discloses a process of subjecting water to cavitation in order to breakdown large clusters of water molecules into smaller clusters. The process involves subjecting the liquid to elevated pressure and then depressurizing the liquid to a lower pressure rapidly. The cavitation device consists of 4 pump volutes with impellers removed. Water to be treated enters the four volutes via the discharge side of the pump. The water is directed in a circle in order to establish rotational vortices that spin the water in one rotation of 360°. Subsequently, the water is discharged into a common chamber and stored.

U.S. Pat. No. 5,435,913 discloses a device for the production of potable water, the device having 2 pairs of cascaded vortex nozzle positioned in opposed relation and a common chamber into which the water is discharged. Water discharged from one pair of nozzles are made to collide with the water discharged from the other pair of nozzles. It is said that the collision brings about compression waves which breaks down the cluster structure of the water.

U.S. Pat. No. 6,505,648 discloses a device for treating a liquid which combines the use of a cavitation structure and an ultrasound device to promote cavitation in the liquid. Ultrasound is generated electrically by means of a piezoelectric ultrasound generator positioned at a passageway within the device through which liquid passes.

Despite these developments, there remains a need for alternative devices and methods to treat water by cavitation that involves low capital outlay and operating costs. In view of such a need, it is an object of the invention to provide a device for treating aqueous liquids effectively by means of cavitation. It is also desirable to provide a device that can continuously treat large volumes of aqueous liquids and which has a long turnaround time before the device needs to be replaced.

These objectives are solved by the device for treating aqueous liquids, having the features of the independent claim.

In one aspect, such a device comprises at least 2 treatment units arranged in series. Each treatment unit comprises a flow compartment which fluidly connects a liquid outlet, and a liquid outlet. A cavitation inducing means for inducing cavitation in the aqueous liquid is present in the device, said means including a constriction means provided at the liquid inlet and/or the liquid outlet for increasing the velocity of the aqueous liquid, thereby reducing liquid pressure.

Each treatment unit includes a flow compartment and a liquid inlet through which the aqueous liquid enters, and a liquid outlet through which the aqueous liquid subsequently leaves the flow compartment. The flow compartment is derived from any suitable hollow container, such as a cylindrical container, the inlet being an aperture at one end of the cylinder and the outlet being an aperture at the other end of the cylinder. The flow compartment is not restricted to cylindrical shapes, but can assume any other suitable shape, including regular spherical, cuboid, dome and bottle shapes. The flow compartment may also have any suitable dimension. Apart from the above listed regular shapes, the flow compartment may furthermore be irregularly shaped (i.e. having no line of symmetry) including, for example, convoluted tubular shapes, as well as a composite flow compartment obtained by combining several irregularly and/or regularly shaped compartments to form a single, fluidly connected flow compartment.

Each treatment unit further comprises cavitation inducing means for inducing cavitation in the aqueous fluid to be treated (hereinafter used interchangeably with “cavitation means”). Any suitable structural feature that can implement techniques known to the skilled person for cavitating a liquid can serve as the cavitation inducing means, so long as said cavitation is able to impart energy to the aqueous liquid to assist in the disruption of the cluster structure of the molecules. The cavitation inducing means may be in the form of a cover or cap (hereinafter known as a “cavitation cover” and “cavitation cap”, respectively) that can be fastened to the inlet and/or outlet of the flow compartment, for example.

In order for cavitation to take place, liquid passing through each treatment unit is subjected, firstly, to de-pressurization, and secondly, pressurization. Both pressurization and depressurization can be carried out to any desired pressure levels. Most preferably, the de-pressurization occurs such that vapor pockets or bubbles are formed in the liquid. Furthermore, it is also preferable that pressurization should be sufficient to bring about the collapse/implosion of the bubbles. Implosion of the bubbles results in strong hydraulic collisions in the liquid, resulting kinetic energy being imparted to the liquid molecules such that the inter-molecular forces within large arrays/clusters of molecules in the liquid are overcome, thereby disrupting or breaking down large clusters into smaller clusters.

The step of pressurization is carried out in the device of the invention by passing the aqueous liquid to be treated through a cavitation inducing means comprising a constriction means provided at one of or both liquid inlet and liquid outlet. By applying to a fluid which flows through a one-dimensional converging passageway the Bernoulli equation (1):

$${p}_{1} - {p}_{2} = \frac{1}{2} ρ ( {V}_{2}^{2} - {V}_{1}^{2} )$$

and the one-dimensional continuity equation (2):

A₁V₁=A₂V₂

wherein
p=pressure of the liquid,
ρ=density,
V=velocity,
A=cross-sectional area
subscript 1=reference to inlet
subscript 2=reference to outlet,
it can be seen that pressure difference (p₁−p₂) becomes positive for a passageway in which the cross-sectional area of the outlet (A₂) is smaller than the inlet (A₁), liquid velocity V₂ is larger than V₁. This means that the pressure p₂ is made smaller than p₁ at the smaller cross-sectional area. Consequently, the area of the passageway in the constriction means through which the aqueous liquid moves is selected such that liquid pressure is lowered. While it is preferable to reduce liquid pressure to a level which is between slightly above the vapor pressure of the aqueous liquid to a level slightly below its vapor pressure, it is not necessary to do so. However, if liquid pressure is not lowered below the vapor pressure of the aqueous liquid, vaporization, and hence cavitation, does not take place.

Suitable constriction means includes any structure suitable for increasing the velocity of liquid flow, including, but not restricted to, through-holes or constricted passageways defined in cavitation caps used for covering the inlet and outlet of a cylindrical flow compartment, or such cavitation caps with nozzles attached to the holes present. The holes may be circular, rectangular, elliptical or square shaped. Obstructions may also be positioned at the holes or placed within the constricted passageways so as to lower the cross-sectional area through which liquid flows through the hole or nozzle, thereby further increasing the velocity of liquid flowing over the obstruction.

In one embodiment, the constriction means comprises at least one nozzle having a cross-sectional area selected such that the pressure of the aqueous liquid in the nozzle is lowered below the vapor pressure of the aqueous liquid, thereby inducing the vaporization of the aqueous liquid. In a presently preferred embodiment, the at least one nozzle is defined in a recessed surface located on a circular cavitation cap that is adapted to cover the liquid inlet and/or the liquid outlet of the flow compartment. The recessed surface may be located on the side of the circular cavitation cap that faces away from the flow compartment. In another presently preferred embodiment, the constriction means includes 4 nozzles, each nozzle being in fluid communication with a hole/aperture present in the above-mentioned circular cavitation cap.

In one embodiment, the cavitation inducing means further comprises discharge means (also referred to as a ‘discharger’ in the following) located downstream of the constriction means. The discharge means decreases the velocity of the aqueous liquid, thereby increasing liquid pressure. In other words, the discharge means serves to increase liquid pressure sufficiently to bring about the collapse/implosion of bubbles that have formed due to the constriction means. It can be present, for example, in the form of a discharge region or discharge space fluidly connected to the constriction means and receives aqueous liquid discharged from it. In order to bring about the increase of liquid pressure, the discharge means/discharger can assume the form of a discharge region having a larger cross-sectional area than the constriction means. The passageway may assume any suitable regular or irregular shape, such as a cylindrical, hemispherical, conical (i.e. it may taper outwardly from the constriction means, such that said tapering outwards provides a gradual enlargement of the passageway) or cuboidal shape. In order to ensure that the implosion of vapour bubbles occurs, the discharge means preferably comprises a discharge region having a cross-sectional area selected such that the pressure of aqueous liquid in the discharge region is raised above the vapour pressure of the aqueous liquid, thereby inducing the implosion of vaporised aqueous liquid.

Apart from carrying out cavitation in the aqueous liquid, other subsidiary processes can be carried out on the aqueous liquid in order to assist in the break down of the cluster structure of the liquid molecules. In one embodiment, nozzles that are implemented as the constriction means are arranged such that the trajectories of the aqueous liquid leaving each nozzle converges at one location in the discharge means, thereby resulting in the collision of the liquid streams. In another embodiment, the nozzles are positioned such that the trajectory of aqueous liquid emanating from each nozzles is directed into a spiral, either clockwise or counter clockwise, thereby causing the aqueous liquid to spin within the flow compartment. It is presently believed that by additionally generating turbulence in the aqueous liquid, e.g. by bringing about the collision of the liquid streams, or by causing the aqueous liquid to flow through bents or by establishing vortex motion in the aqueous liquid, it is possible to enhance the disruption of the cluster structure of the liquid molecules.

The term “vortex motion” as applied to the flow of liquid that is being treated in the device of the invention encompasses all forms of fluid flow characterized swirling motion in the liquid, including rotational vortex motion as well as vortices resulting from separation (e.g. vortex shedding) and starting vortices. Furthermore, the term includes not only vortex flow per se, but includes bulk fluid flow along a vortex-shaped route within the device of the invention. Such a route may be provided, for instance, by connecting treatment units in a spiral formation, or by coupling treatment units to spiral-shaped auxiliary units. In this manner, the motion of the bulk fluid is made to follow the spiral route defined in the device, thereby achieving bulk vortex flow. In addition, the term “vortex motion” also encompasses any form of turbulent fluid flow achievable through moving the treated liquid through a bent, thereby causing a change in the direction of fluid flow. This may be achieved by coupling the treatment units to auxiliary units such as a u-bend (which causes the liquid to make a 180° change in direction) or an elbow (which causes the liquid to make a 90° change in direction), for example.

In one embodiment, the flow compartment is annular shaped. The annular shape is comprises the annular space defined between an elongate inner core and an outer sheath (hereinafter termed interchangeably with the terms “shell” and “cover”) that houses said core, said inner core being positioned concentrically within the outer sheath. In one embodiment, the inner core is in the form of an axial support bar connecting the constriction means located at the liquid inlet and the constriction means located at the liquid outlet. The axial structure may be positioned at any position within the flow compartment as long as it provides structural support for the constriction means at the inlet and the outlet. Preferably, the concentric support bar is positioned substantially along the (central) longitudinal axis of the flow compartment (i.e. axial location), thereby occupying a concentric position in the flow compartment. Accordingly, in the presence of an axial/concentric support bar, the flow compartment assumes an annular shape, said annular shape being the shape defined between an outer cover and the inner core/bar. In a presently preferred embodiment where the treatment unit is derived from cylindrical components, the flow compartment comprises the annular space defined between an outer cylindrical cover and an inner cylindrical core.

All parts of the present device of the invention, including the flow compartment, cavitation inducing means, coupling means, securing means and axial support bar etc., can be made of any suitable material that does not contaminate the aqueous liquid being treated. Suitable materials should preferably be approved for use in the supply of water for drinking, washing, cooking or food production (also known as “food grade” materials), including metals such as copper and various standard grades of stainless steel (preferably, but not limited to, chloride resistant grades) such as 316, 316L, 304, 304L, 904L and 2205. In other embodiments, alloys comprising iron, nickel, chromium, molybdenum and manganese and mixtures thereof may be used. Other materials which may be used include, but are not limited to, silicon, carbon, polyethylene (for vinyl pipes) and polypropylene, to name a few examples.

In a preferred embodiment, the axial support bar comprises a magnetic material. It is believed that presence of the magnet helps to reduce scale deposition, remove existing scale or produce a softer and less tenacious scale on the axial support bar, thereby ensuring that each treatment unit has longer process life. The anti-scale effect is believed to result from changes in crystallization behaviour which promotes formation of bulk solution precipitate rather than adherent scale precipitate.

In another embodiment, the flow compartment is divided into sub-compartments, each of which may optionally either be fluidly connected to the other sub-compartments, or be fluidly isolated from the other sub-compartments. For example, in embodiments which include an axial support bar, the bar may further include 1, 2, 3, 4 or more partitioning plates, one edge of each plate being affixed along the entire length of the bar and the other edge stretching radially from the surface of the bar to the inner wall of the outer cover. For example, if it is desired to have 2 flow compartments, 2 partitioning plates may be affixed on opposite sides of the bar; if 4 flow compartments are desired, 4 partitioning plates may be used, each being placed at 90 degrees to each other. An alternative to partitioning plates are individual pipes which connect each fluid aperture or nozzle of the constriction means at the inlet to a corresponding outlet fluid aperture or nozzle of the constriction means at the outlet.

In the present invention, at least 2 treatment units are present. Each treatment unit is connected to another unit in series, meaning that the outlet of one treatment unit is connected to the inlet of another treatment unit so that the aqueous liquid to be treatment passes from one treatment unit to another. In this manner, successive cavitation is carried out so that the breakdown of the cluster structure of the aqueous liquid is more effective. Therefore, one possible method of effecting stronger cavitation on the aqueous liquid (for example when processing highly clustered water) is to connect more treatment units in series. In presently preferred embodiments, the number of treatment units that are connected in series is preferably between 3 to 5 units. Most preferably, 4 units or 4n units (with n being an integer from 2 to 5) are connected in series to form the complete device of the invention.

In one embodiment, treatment units are coupled via an intervening coupling means. The coupling means refers to any structure that can convey liquids from one treatment unit to another. Some examples of a coupling means include a connecting pipe, rubber tubing, aeration tank, or any subsidiary treatment units such as a filter unit or a chemical treatment unit. In a presently preferred embodiment, the coupling means is selected from the group consisting of 2-way dividers, elbow stem adapter, equal elbow connector, equal straight connector, female adaptors, male adaptors, reducing elbows, tees, ells and threaded stem adaptors. The coupling means may comprise materials selected from the group consisting of brass, stainless steel and plastics.

Connections between treatment units and coupling means can be established by securing means that provides secure attachment between each treatment unit and its associated coupling means. Typically, the securing means is located at the inlet and/or the outlet of each treatment unit. The securing means can be any structure that provides secure fastening between two pipes, such as a screw-thread section or a clip-on fastener. A secure attachment can also be provided by using connecting structures such as compression fittings, flanged fittings, flare fittings, sweat fittings, bulkhead fittings/connectors and flangeless fittings at the liquid inlet/outlet. Standard brass or stainless steel connectors with cross-sectional diameters (for circular connectors,) or widths (for other geometries) of ½ inch, ¾ inch, or ⅜ inch or any other dimensions may be used, depending on the factors such as the flow rate of water it is desired to achieve in the device and the operating fluid pressure.

If the device of the invention includes several (i.e. 3, 4 or 5 or more) treatment units that are connected in series, the units can be arranged according to any suitable layout. The layout may be such that space occupied by the device is minimized, or the layout may be such that the aqueous liquid being treated is made to flow according to a predetermined flow pattern or route, for example. In certain embodiments, the treatment units are arranged into a single vertical column. Alternatively, they can be arranged into a horizontal file. In order to minimize space occupied by the entire device, the treatment units may be arranged in a vertically stacked formation, such as a vertically stacked-horizontal file formation in which stacks of 2, 3 or 4 units are arranged to be stacked on top of each other. If desired, the treatment units may be protected within a hermetically sealed protective housing.

Apart from establishing vortex motion in the liquid within the flow compartment of each treatment unit (for example, via curved nozzles attached to the inlet), it is possible to cause the bulk liquid to flow through a vortex-shaped route, thereby achieving bulk vortex motion. This can be implemented, for instance, by arranging the treatment units along with coupling means such that fluid channel/route defined therein is spiral-shaped or any other tortuous route that is able to cause turbulence in the liquid. Auxiliary units having a spiral-shaped fluid passageway defined therein may also be used as coupling means. It is presently believed that the effects of cavitation is magnified, i.e. the cluster size of clustered liquids can be reduced more effectively, by generating turbulence in the liquid as well as by causing the liquid to flow along a tortuous pathway within the device.

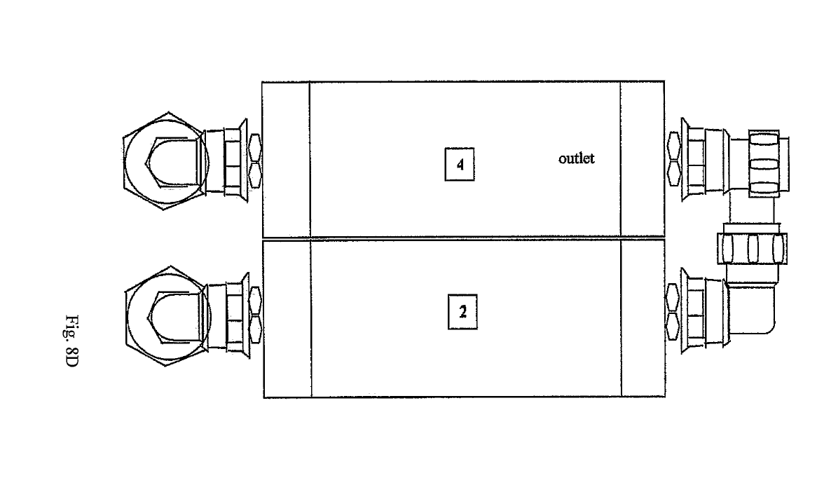

In one embodiment, bulk vortex flow is implemented by arranging treatment units in a spiral formation, or by attaching spiral coupling means between treatment units. For example, treatment units can be arranged in vertical stacks of 2, 3 or 4 units (hereinafter referred to as a “stack”). These units are arranged and connected such that a spiral fluid pathway is defined, thereby causing the treated liquid to travel spirally through the stack according to the spiral arrangement of the treatment units (see FIGS. 8A to 8D).

If desired, coupling means comprising U-bend connectors may be used to connect the treatment units so that liquid flow experiences a change in direction of about 180° each time it flows from one treatment unit to another, thereby generating turbulence in the aqueous liquid being treated. U-bend connectors may have rounded bends or sharp-edged bends. An alternative to u-bend connectors are two elbows that are inclined at an angle of about 90° and which are interconnected by a straight pipe. A further alternative is a 3-section elbow comprising an intermediate section connected at an obtuse angle between the 2 orthogonal arms of the elbow. Alternatively, the coupling means may comprise spiral tubes, converging tubes, tubes that define an irregular convoluted flow path, and any other type of configuration that increases the tortuosity of fluid flow through the device.

The present invention is can be operated under any suitable operating conditions, such as elevated temperature and elevated pressure. Auxiliary heating, cooling or pressure devices may thus be provided to help achieve the desired treatment conditions. No restriction presently exists as regards the operating conditions, and it is entirely possible to carry out the treatment of aqueous liquids under any combination of temperature and pressure to obtain a desired quality in the aqueous liquid being treated.

Aqueous liquids that can be treated using a device of the present invention include natural precipitation obtained from reservoirs, processed tap water, sea water, industrial water, ground water, and any water-based liquid foods such as fruit juices, alcoholic drinks, tea and coffee beverages.

The device of the present invention can be used alone or in combination with any known or commercially available water treatment devices such as KDF-55 filters, granular activated carbon filters, ozonators, reverse osmosis devices, water softeners, and other water treatment chemicals.

Other objects, advantages and features of the present invention will be apparent from the following detailed description of preferred embodiments thereof with reference to the attached drawings, in which:

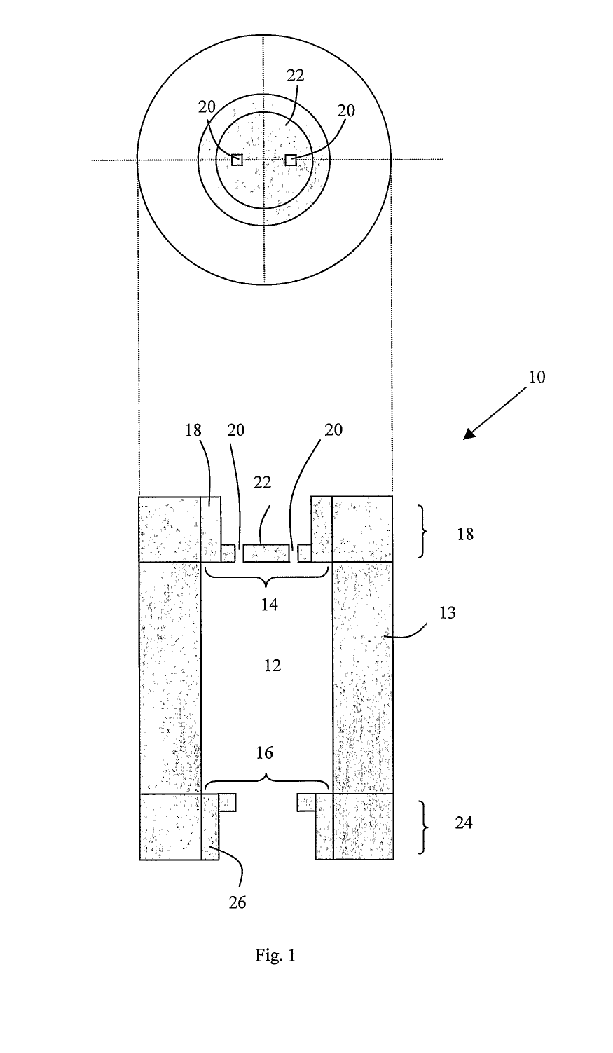

FIG. 1 shows an isometric and top view of one embodiment of the device according to the invention. A cavitation cap is secured to only the inlet of the flow compartment and has 2 constricted passageways defined therein.

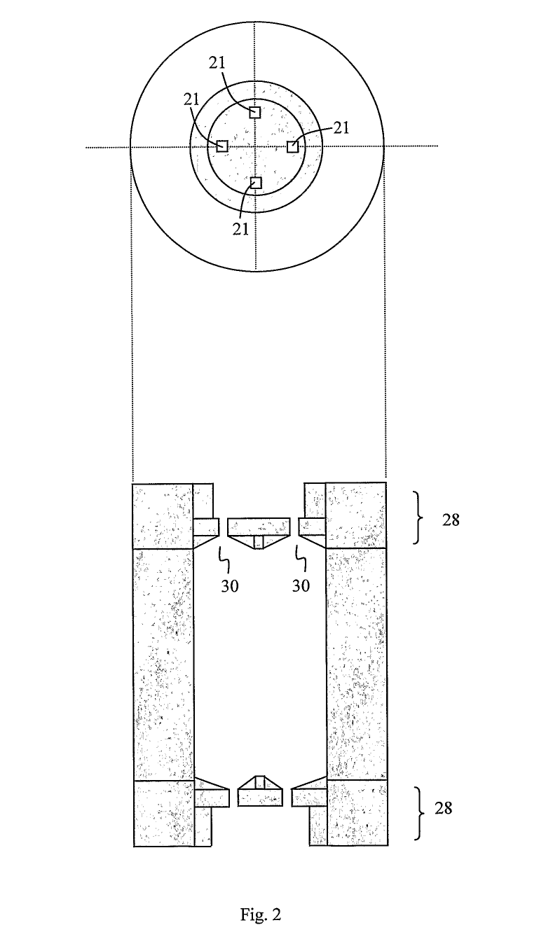

FIG. 2 shows an isometric view of another embodiment of the device incorporating 2 cavitation caps each having 4 constricted passageways defined therein and each being located at both the inlet and the outlet of the flow compartment.

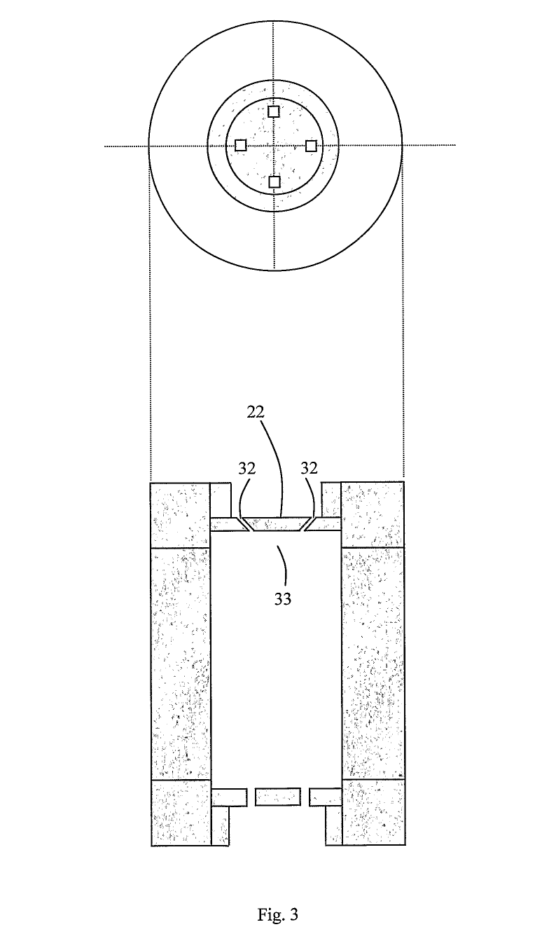

FIG. 3 shows an isometric view of another embodiment of the device in which the 4 constricted passageways defined in the cavitation cap are arranged to cause liquid leaving the constricted passageway to mutually collide. The cavitation cap at the inlet is different from the cavitation cap at the outlet.

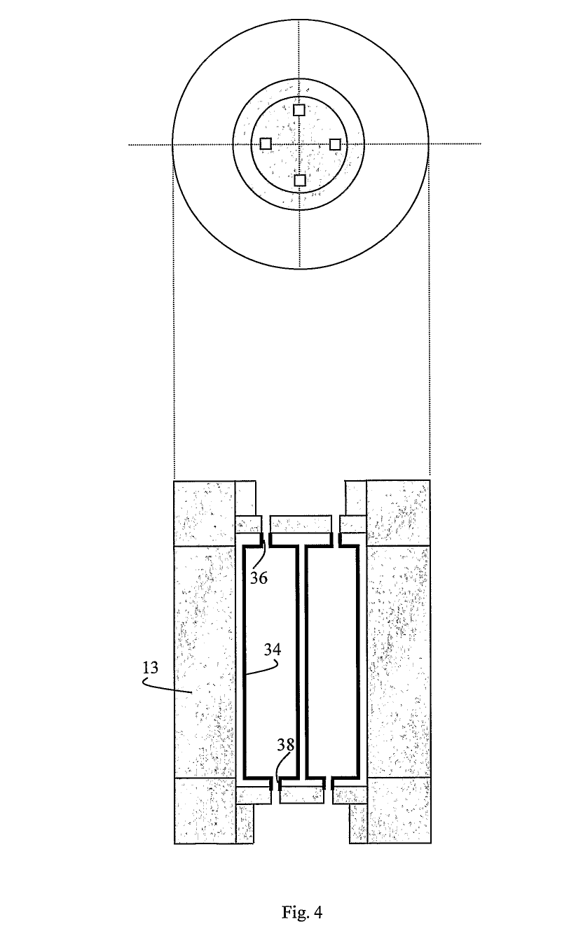

FIG. 4 shows another embodiment of the device in which 2 constricted passageways present at the inlet cap and the outlet cap are each fluidly connected to a respective constricted passageway at the outlet via connecting pipes.

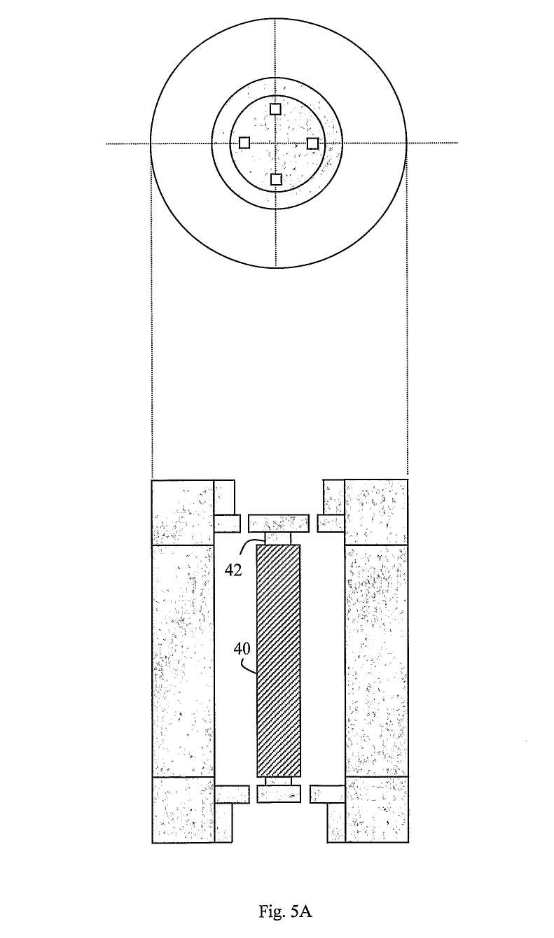

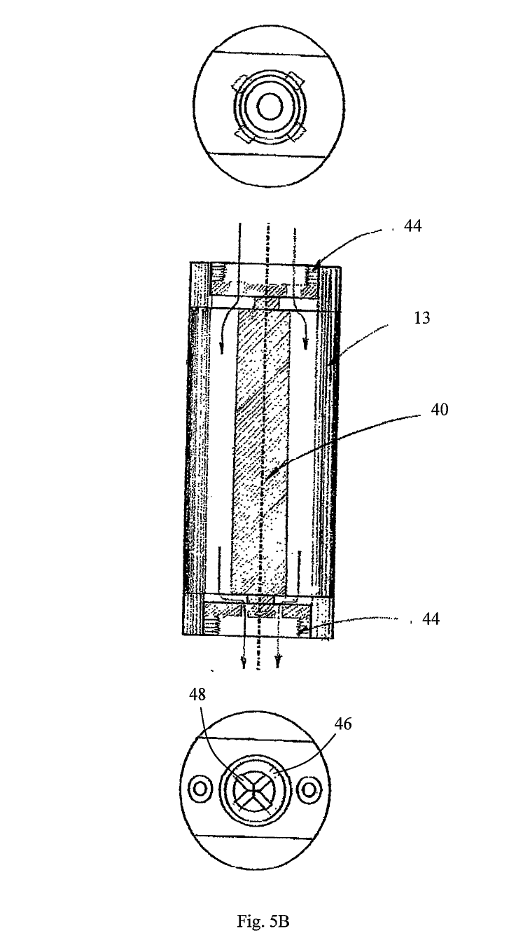

FIG. 5A shows a further embodiment of the device in which a concentrically located support bar is present within the flow compartment. FIG. 5B shows a further embodiment of the device in which a concentrically located support bar is present within the flow compartment. The securing means present comprises compression fittings.

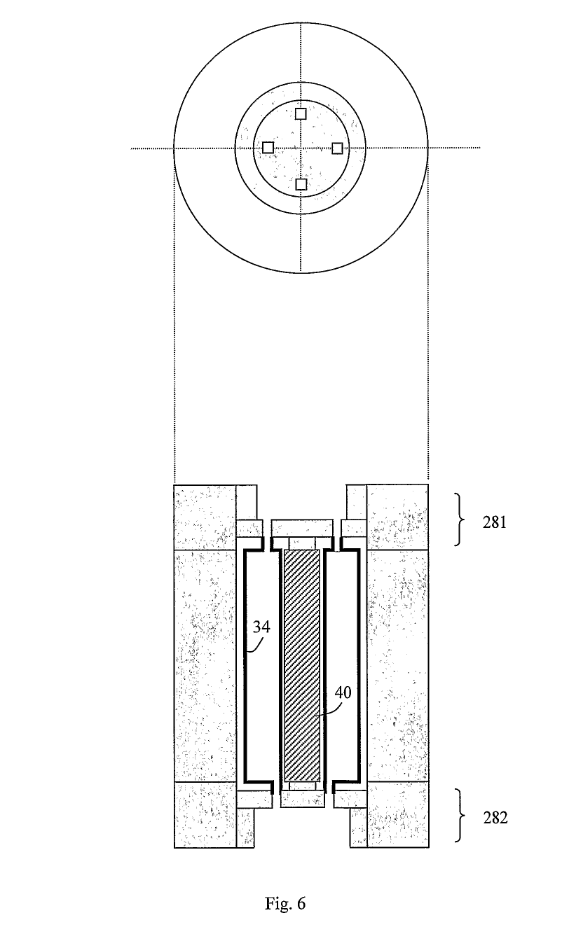

FIG. 6 shows yet another embodiment of the device combining the use of a concentrically positioned support bar and 4 pipes positioned parallel to the support bar. Each pipe individually links the 4 constricted passageways at the inlet to respective constricted passageways at the outlet.

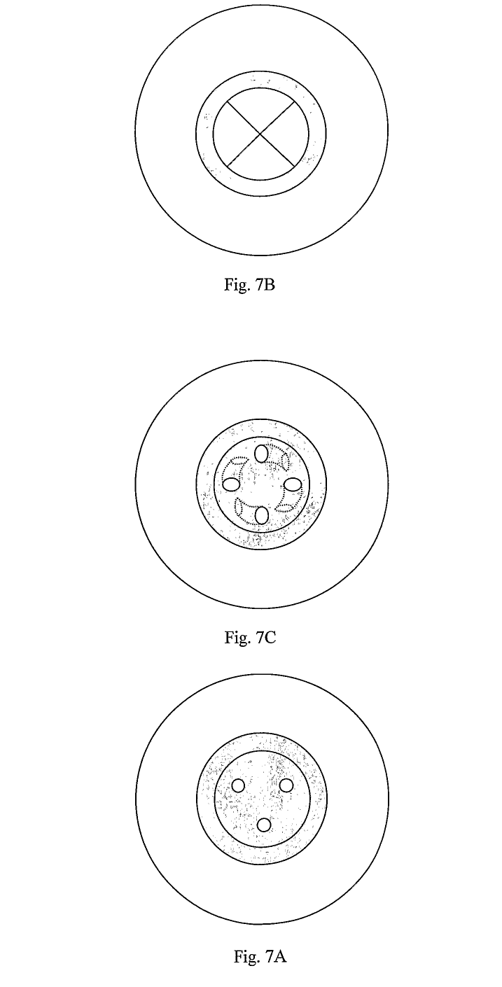

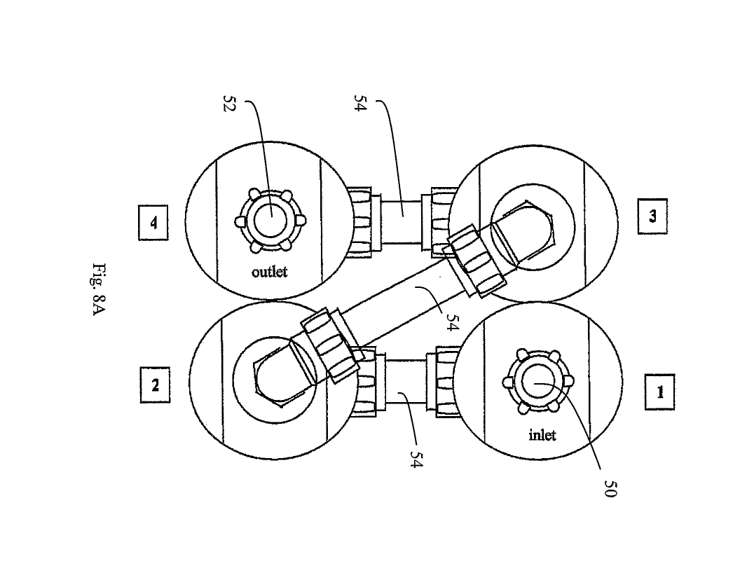

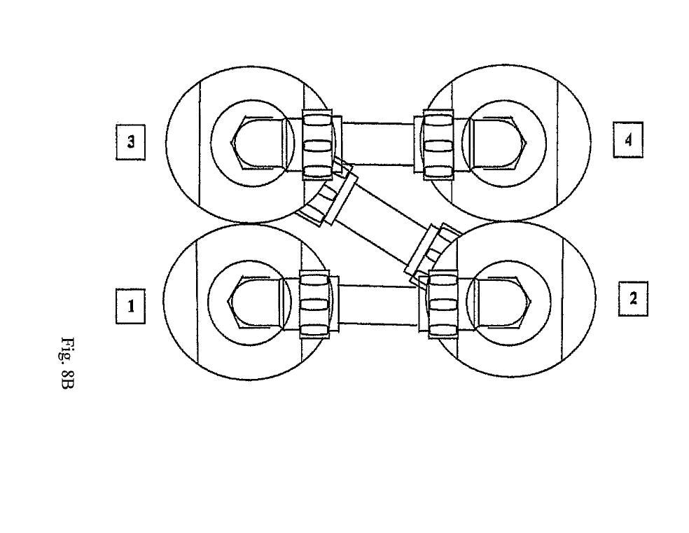

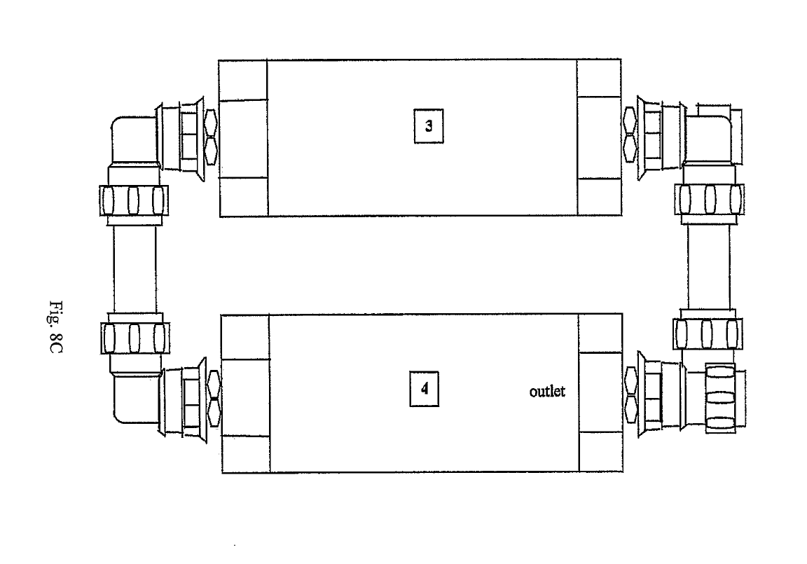

FIG. 7A to 7C show various embodiments of the constriction means. FIG. 7A depicts 4 constricted passageways each shaped as a quadrant. FIG. 7B depicts 3 constricted passageways each shaped as a circle. FIG. 7C depicts 4 constricted passageways, each of which is connected to a nozzle that extends into the flow compartment. The exit holes of the 4 nozzles are arranged such that water leaving the nozzles are directed in a spiral motion, thereby establishing vortex liquid motion in the flow compartment.

FIGS. 8A to 8D show the right-side view, left side view, top and bottom view of one embodiment of the device in which 4 treatment units are connected in series. In this embodiment, the 4 treatment units are arranged in 2×2 stacked file formation.

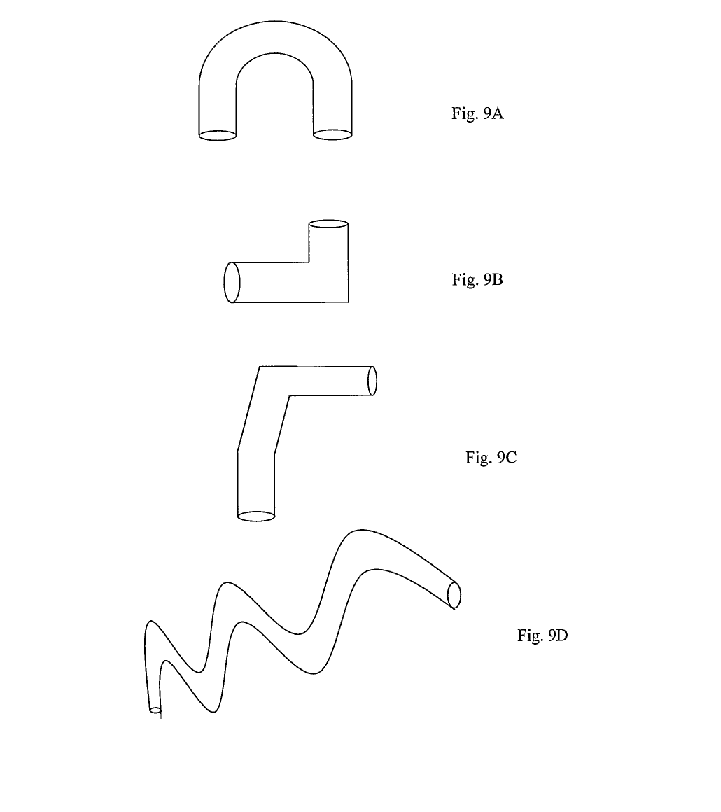

FIG. 9A to 9E depict several embodiments of a coupling means. FIG. 9A shows a u-bend connector; FIG. 9B shows a 90° elbow; FIG. 9C shows a 3-section elbow comprising an intermediate section connected at an obtuse angle to each of the other 2 orthogonal arms of the elbow; FIG. 9D an irregularly shaped convoluted tube.

FIG. 1 shows one embodiment of a treatment unit 10 which is employed in the invention for treating aqueous liquids. The treatment unit is generally cylindrical in cross-section, and comprises a flow compartment 12 defined within a cylindrical shell 13, said flow compartment having an inlet 14 and outlet 16. The inlet 14 is connected to a cavitation inducing means generally in the form of a cap 18 (hereinafter also known as a “cavitation cap”) that can be securely fastened over the inlet 14. The cavitation inducing means comprises two constricted passageways 20 located at a recessed surface 22 on the cap 18. The constricted passageways allow fluid to flow from an external source into the flow compartment 12. The fluid subsequently leaves the flow compartment via the outlet 16. The fixture 24 forms part of the outlet 16, and allows the outlet of the treatment unit 10 to be connected either directly to the inlet of another treatment unit or to a connecting device such as a flanged fitting.

The size of the constricted passageways 20 are determined in accordance with standard fluid mechanics principles and are designed to reduce the pressure of liquid passing through the constricted passageway, preferably such that the liquid pressure is sufficiently low so that the aqueous liquid vaporizes. Liquid leaving the constricted passageways 20 enters into the flow compartment 12. Due to the relatively larger cross-sectional area of the flow compartment, the liquid is entering the flow compartment is re-pressurised and bubbles in the liquid cavitate/implode. The hydraulic impact of the implosion provides the required energy to disrupt the cluster structure of the liquid as intended.

The treatment unit may incorporate 1 or 2 cavitation inducing means. FIG. 2 shows an embodiment in which two identical cavitation caps 28 are attached to the liquid inlet and the liquid outlet, each cap having 4 constricted passageways 21. In this manner, the aqueous liquid is subjected to two rounds of cavitation per treatment unit, once at the liquid inlet, and once at the liquid outlet. In this embodiment, cavitation cap 28 differs from cavitation cap 18 in that it includes a discharge region 30 that serves to allow any vapor generated in the liquid leaving the constricted passageways 20 to cavitate.

In a preferred embodiment, the axis of each of the 4 constricted passageways in the cavitation caps is arranged in such a manner that the trajectory of the aqueous liquid leaving the nozzles converges at the center of the discharge region or flow compartment, thereby resulting in the collision of the liquid streams leaving the constricted passageway. FIG. 3 shows a possible implementation of this arrangement in which each of the 4 constricted passageways 32 in the cavitation cap located at the liquid in let are arranged to be slanted at about 45° with respect to the recessed surface 22. The impact of collision of the liquid streams at the region 33 may impart additional energy to the liquid for enhancing disruption of the cluster structure of liquid molecules.

Instead of using treatment units which have a single flow compartment, it is possible to attach pipes 34 that extend from constricted passageways at the inlet to corresponding constricted passageways at the outlet as shown in FIG. 4. In this embodiment, each of the pipes 34 has an inlet nozzle 36 and an outlet nozzle 38. The inlet nozzle 36 is connected to a constricted passageway at the inlet cap, while the outlet nozzle 38 is connected to a constricted passageway at the outlet cap. In this manner, the liquid to be treated is separated into individual pipes when it enters the treatment unit. Each pipe may incorporate comprise different treatment materials or loaded with filter media or chemicals so that the aqueous liquid being processed is subjected to a variety of processes within a single treatment unit. Typically, straight pipes are used and are arranged parallel to each other within the outer shell 13. Alternatively, the pipes 38 may be shaped as a spiraling tube or an irregularly shaped convoluted tube to increase the vorticity of liquid flow.

The recessed surface of the cavitation cap 28 in the embodiment shown in FIG. 5A is supported by a concentrically located support bar 40 (used interchangeably with the term “support rod” in the specification). This feature may be useful for improving the performance of the treatment unit by providing mechanical support for the recessed surface on the cavitation cap, thereby possibly reducing mechanical fatigue on the recessed surface due to hydraulic pressure from the liquid flow. In one embodiment, the support bar 40 is screwed onto the recessed surfaces 22 at the side facing the flow compartment. A washer 42 may be interposed between the support bar and the recessed surface to improve the screw connection. FIG. 5B shows a further embodiment in which compression fittings 44 are incorporated into the cavitation cap to provide secure attachment of the treatment unit to another treatment unit that is capable of withstanding high treatment pressures. In this embodiment, constricted passageways 46 in the cavitation cap located at the liquid outlet is provided with nozzles 48 that are arranged such that liquid leaving the nozzles collide around the center of the recessed surface.

It is also possible to combine the use of a support bar 40 with connecting pipes 34 as described in the previous embodiment. FIG. 6 shows another embodiment of the device combining the use of connecting pipes 34 and a concentrically positioned support bar connected between the cavitation cap 281 located at the liquid inlet and the recessed surface of the cavitation cap 282 located at the liquid outlet.

FIG. 7 show various embodiments of the cavitation cap that can be used in the present invention. FIG. 7A depicts three constricted passageways each shaped as a circle. FIG. 7B depicts four constricted passageways each shaped as a quadrant FIG. 7C depicts four constricted passageways, each of which is connected to a curved nozzle that extends through the constricted passageway into the flow compartment. The exit holes of the four nozzles are arranged such that water leaving the nozzles are directed in a spiral motion, thereby creating vortex motion in the treated liquid within the flow compartment.

The present device comprises at least two treatment units connected in series. FIGS. 8A to 8D show a preferred embodiment of the invention in which four treatment units labeled 1, 2, 3, and 4 are connected in series. In order to minimize the space required by the 4 treatment units, the treatment units are arranged into a compact horizontal 2×2 formation, as can be seen from FIG. 8A. Liquid to be treated enters treatment unit 1 via a main inlet 50 and is delivered to adjacent treatment unit 2. Liquid leaving treatment unit 2 enters diagonally adjacent treatment unit 3. Finally, liquid leaving unit 3 enters treatment unit 4, and then leaves treatment unit 4 through main outlet 52 from the same side as the main inlet 50. U-bend or elbow-type fluid connectors obtainable from Hydralectric Appliance Controls, (Surrey, UK) can be used to connect the outlet of one unit to the inlet of another unit. In this embodiment, three elbow-type connectors 54 are used. The type and configuration of fluid connectors used for connecting treatment units depend on factors such as the desired arrangement of the treatment units. Where a compact arrangement is not necessary and the treatment units are arranged in a single file/column, other types of fittings apart from elbow-type connectors may be used, including high-pressure compression fittings or flangeless fittings obtainable from Valco Instruments Co. Inc. (TX, US).

### EXAMPLES

This example describes one method of treating a water sample and the corresponding results of the treatment.

Water sample was obtained from Chicken Farm Cage No. 2 at Ayer Tawar, Sitiawan (Perak, MY). 100 gallons of sample water was processed using the arrangement shown in FIGS. 8A to 8D. Individual treatment units were fabricated according to the embodiment depicted in FIG. 5B. The dimensions of each treatment unit were measured as follows: length—104 mm (including the 2 cavitation caps), outer diameter—45 mm, diameter of recessed surface of the cavitation cap at the inlet—9.5 mm. In the arrangement shown in FIG. 8B, the width from unit 3 to unit 4 measured 126 mm from end to end. The width from unit 1 to unit 3 measured 90 mm from end to end. The total height of the unit measured along unit 3 (including the coupling device at the inlet and the outlet) was 194 mm (with reference to FIG. 8C). Cylindrical copper outer shells and solid cylindrical copper support bars were used. Each treatment unit comprises 2 cavitation caps, each cap having 4 constricted passage ways defined in the recessed surface as described above. In this particular example, water was passed through the device at a flow rate of about 0.4 liters per second. The flow rate at which treatment is carried out is, however, not restricted to 0.4 liters per second, but may be higher or lower than 0.4 liters per second, depending on factors such as the size of the treatment units being used. For example, if larger treatment units than the ones in the present example are used, higher flow rates may be applied; conversely, if smaller treatment units are used, lower flow rates may be applied. The choice of appropriate flow rates is well within the knowledge of the person of average skill in the art.

Qualitative analysis on the sample water was carried out prior to treatment. The Standard Methods for the Examination of Water and Wastewater, 19th Edition, 1995 (American Public Health Assoc.) was followed. The results of the analysis are tabulated in the following Table 1:

TABLE 1

| Test Parameters | Units | Results | Method Reference |
|---|---|---|---|
| pH | — | 4.8 | APHA 4500-H + B |
| Dissolved Oxygen | mg/l | 0.78 | APHA 4500-O G |
| Total Bacteria Count | cfu/100 ml | 2.3 × 10⁵ | APHA 9215 D |
| Total Dissolved | mg/l | 58 | APHA 2510 B |
| Solids | | | |
| Hardness | mg/l | 4 | APHA2340 B |
| Chlorine | mg/l | <0.1 | APHA 4500-Cl G |

Samples of treated water was obtained directly from the outlet of the treatment device. Qualitative analysis on the sample water was carried out once again. The Standard Methods for the Examination of Water and Wastewater, 19th Edition, 1995 (American Public Health Assoc.) was followed. The results of the analysis are shown in Table 2:

TABLE 2

| Test Parameters | Units | Results | Method Reference |
|---|---|---|---|
| pH | — | 6.3 | APHA 4500-H + B |
| Dissolved Oxygen | mg/l | 4.60 | APHA 4500-O G |
| Total Bacteria Count | cfu/100 ml | ND (0) | APHA 9215 D |
| Total Dissolved | mg/l | 32 | APHA 2510 B |
| Solids | | | |
| Hardness | mg/l | 3 | APHA2340 B |
| Chlorine | mg/l | 1.0 | APHA 4500-Cl G |

*ND = not detectable

Comparing the results of the analysis, it can be seen that pH of the water was increased from 4.8 to 6.3, which is near to neutral pH. Amount of dissolved oxygen in the water increased more than 5-fold. Most significantly, the total bacteria count in the treated water dropped significantly, to a level where it was not detected based on the test method.

In a further test using the device of the invention, the device in FIG. 5B was used to purify tap water obtained from the public water supply in Jakarta (Indonesia). After the treatment, the water was found to be free of bacteria (i.e. below a detectable level based on APHA detection methods). The treated water was also found to be safe for human consumption.

1. A device for treating aqueous liquids, comprising:
at least 2 treatment units connected in series, each treatment unit comprising:
a liquid inlet,
a liquid outlet,
a flow compartment fluidly connecting said liquid inlet to said liquid outlet, and
cavitation inducing means for inducing cavitation in an aqueous liquid to be treated, said means comprising
constriction means provided at the liquid inlet and/or the liquid outlet for increasing the velocity of the aqueous liquid, thereby reducing liquid pressure.

2. The device according to claim 1, wherein said means for inducing cavitation further comprises:
discharge means located downstream of the constriction means for decreasing the velocity of the aqueous liquid, thereby increasing liquid pressure.

3. The device according to claim 1, wherein said constriction means comprises at least one nozzle having a cross-sectional area selected such that the pressure of aqueous liquid in the nozzle is lowered below the vapour pressure of the aqueous liquid, thereby inducing the vaporization of the aqueous liquid.

4. The device according claim 3, wherein said discharge means comprises a discharge region having a cross-sectional area selected such that the pressure of aqueous liquid in the discharge region is raised above the vapor pressure of the aqueous liquid, thereby inducing the implosion of vaporized aqueous liquid.

5. The device according to claim 3, wherein said constriction means comprises 4 nozzles.

6. The device according to claim 5, wherein the axis of each of the 4 nozzles are arranged to be mutually converging, so that the trajectory of the aqueous liquid leaving the nozzles converges.

7. The device according to claim 5, wherein the 4 nozzles are arranged such that the trajectory of aqueous liquid leaving the nozzles is directed into a spiral.

8. The device according to claim 1, further comprising coupling means for conveying aqueous liquid from one treatment unit to another.

9. The device according to claim 8, wherein said coupling means include u-bend connectors, 2-way dividers, elbow stem adapter, equal elbow connector, equal straight connector, female adaptors, male adaptors, reducing elbows, tees, ells and threaded stem adaptors.

10. The device according to claims 8, wherein each treatment unit further comprises securing means for providing a secure attachment between each treatment unit and the coupling means.

11. The device according to claim 10, wherein said securing means comprises an inner sleeve located at the outlet of the first treatment unit that mates in threaded engagement with an outer sleeve located at the inlet of the second treatment unit.

12. The device according to claim 10, wherein said securing means is selected from the group consisting of compression fittings, flanged fittings, bulkhead fittings, and flangeless fittings.

13. The device according to claim 1, wherein the shape of the flow compartment is selected from the group consisting of cylindrical, cuboid, and dome-shaped.

14. The device according to claim 1, wherein the flow compartment is annular shaped, said annular shape being the annular space defined between an inner cylindrical core and an outer cylindrical cover.

15. The device according to claim 14, wherein the inner cylindrical core and/or outer cylindrical cover comprises a material selected from the group consisting of stainless steel, copper, aluminium, iron, nickel, chromium, molybdenum, manganese, silicon, carbon and a mixture thereof.

16. The device according to claim 14, wherein the inner cylindrical core comprises a magnetic material.

17. The device according to claim 1, wherein the flow compartment is sub-divided into 4 sub-compartments.

18. The device according to claim 1, wherein at least 3 treatment units are connected in series.

19. The device according to claim 18, wherein 4 treatment units are connected in series.

20. The device according to claim 18, wherein 5 treatment units are connected in series.

21. The device according to claim 1, wherein said at least 2 treatment units are arranged and connected in a spiral formation.

22. The device according to claim 1, wherein said at least 2 treatment units are arranged within a hermetically sealed housing.

23. The device according to claim 1, wherein the aqueous liquid to be treated is selected from natural precipitation, tap water, sea water, industrial water, ground water, and water-based liquid foods.
